(19) United States
(12) Patent Application Publication
(10) Pub. No.: US 2014/0236775 A1
(43) Pub. Date: Aug. 21, 2014

(54) PURCHASE OF PHYSICAL AND VIRTUAL PRODUCTS

(71) Applicant: AMAZON TECHNOLOGIES, INC., (US)

(72) Inventors: Sunbir Gill, Irvine, CA (US); Mayank Arvindbhai Patel, Brea, CA (US); Alexander Lowell Rouse, Irvine, CA (US)

(73) Assignee: AMAZON TECHNOLOGIES, INC., Reno, NV (US)

(21) Appl. No.: 13/770,752

(22) Filed: Feb. 19, 2013

(51) Int. Cl. G06Q 30/06

(52) U.S. Cl. CPC G06Q 30/0643
USPC 705/27.2; 705/39

(57) ABSTRACT

A computing device can include a retail application and a virtual environment application. The retail application can display a product purchase interface and receive a request to purchase the product from a user. When the user orders the product, the retail application can provide the virtual environment application with an indication that the product has been purchased. In response to the user's purchase of the product, the virtual environment application can grant the user's virtual environment account with ownership of a virtual version of the product.

### BACKGROUND

Virtual environments, such as social networks and other interactive online environments, are increasingly becoming part of everyday life. Social networks, such as FACEBOOK, GOOGLE+ and TWITTER, among others, allow users to create an online account and connect with other user accounts. The user accounts can include elements that identify the user of the account, such as an avatar, an image, personal information, and the like. Users can personalize their user account to create an online persona and to identify themselves to other users. Other interactive virtual environments can include virtual world environments, such as SECOND LIFE, online gaming environments, such as WORLD OF WARCRAFT, and the like. In those virtual environments, a user's account may have an avatar, such as a representation of a person, an animal, a fantastic creature and the like. Frequently, avatars can be customized by users, upgraded based on experiences in the virtual environment and changed for a number of other reasons.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIGS. 1 and 2 depict embodiments of external and internal components of a computing device.

FIG. 3 depicts embodiments of software components operating on a computing device.

FIG. 4 depicts an embodiment of multiple software user interfaces on a computing device display.

FIGS. 5 and 6 depict embodiments of computing devices interacting with physical product retail servers.

FIG. 7 depicts an embodiment of a method for processing an order for a physical product by a physical product retail server.

FIGS. 8A, 8B, 8C and 8D depict embodiments of interactions between software components on a computing device and a physical product retail server.

FIG. 9 depicts an embodiment of a method for processing an order for a physical product by an application operating on a computing device.

### DETAILED DESCRIPTION OF ILLUSTRATIVE EMBODIMENTS

Users of virtual environments may customize representations of their account, such as avatars or profile images. Some users may want to reflect their real-world experiences in the depiction of their avatar or profile image. While avatars and profile images may be crafted to resemble users, users' ongoing life experiences are not easily reflected in avatars and profile pictures without users constantly updating their avatars and profile pictures. In one embodiment, physical products purchased by a user can trigger the user's ownership of a virtual version of the physical product in a virtual environment. For example, when a user orders a physical product, the retailer of the physical product can provide information to a virtual environment provider indicating that the user has purchased the physical product. That information can include an indication of the physical product, a code associated with the physical product, a rendering of the physical product and so on. The virtual environment provider can give the user's virtual environment account access to a virtual version of the physical product. Access to a virtual version of the physical product can include allowing the user's avatar to hold or wear a rendering of the physical product, augmenting a profile picture of the user's account to include a rendering of the physical product, modifying the user's account to indicate that the user owns the physical product and so forth. In this manner, when a user purchases a physical product, the user also gains access to a virtual version of the physical product in a virtual environment.

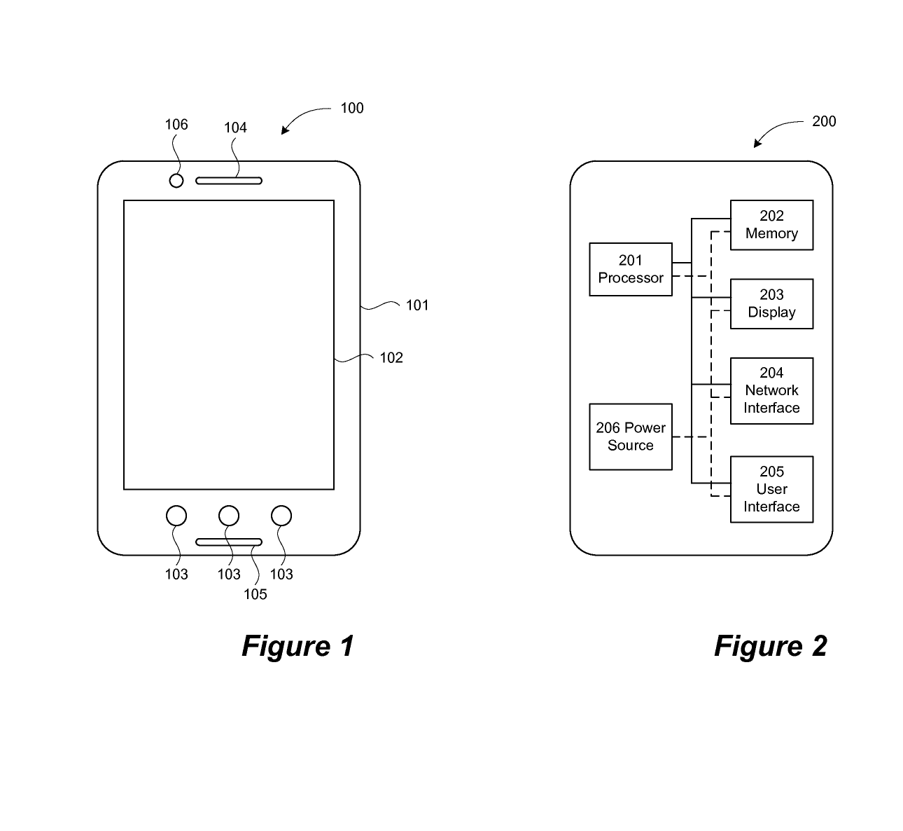

FIG. 1 depicts an embodiment of an exterior of a computing device 100. It should be understood that this is merely an example for discussion, and that a number of additional components, configurations, assemblies and combinations are possible as known in the art. Computing device 100 can be any form of a computer, such as a desktop computer or laptop computer, a tablet computing device, a cell phone, a handheld computing device or any other form of computing device. Computing device 100 can include a housing 101. The housing 101 can be made of any material, or combinations of materials, such as various types of plastic, metal, glass and combinations thereof, that is suitable to house the components of device 100. Computing device 100 can also include a display 102 that can display images, text, or any other type of visual information and any combination thereof. Display 102 can also be a touchscreen display that is capable of sensing the presence and location of one or more touches of the display 102. A touchscreen display can sense touches by a user, such as a touch by a finger or a hand, and touches by objects, such as a stylus. Display 102 can be part of a user interaction system of the computing device 100.

Computing device 100 can also include one or more hard buttons 103 integrated into housing 101. In one embodiment, the one or more hard buttons 103 can include a single button, such as a home button or a power button. In another embodiment, the one or more hard buttons 103 can include a small set of buttons, such as a power button, a home button and a back button. In yet another embodiment, the one or more hard buttons 103 can include a large set of buttons, such as a full QWERTY keyboard, a keypad and the like. The one or more hard buttons 103 can be part of the user interaction system of the computing device 100.

Computing device 100 can also include a speaker 104 configured to emit sounds and a microphone 105 configured to receive sounds. In the embodiment where computing device 100 is a cell phone, speaker 104 and microphone 105 can be used to carry on a telephone call. In one embodiment, speaker 104 can be configured to play sounds associated with graphics displayed on display 102, such as during play of audiovisual material on computing device 100. In another embodiment, microphone 105 can receive audio sounds which the computing device 100 can interpret as user inputs. In addition, while not depicted in FIG. 1, computing device 100 can also include an audio port which can be connected to an external microphone and/or an external speaker or speakers. Computing device 100 can send and receive audio signals via the audio port and interpret the received audio signals via the audio port just as it would interpret audio signals generated from sounds received by the microphone 105.

Computing device 100 can also include one or more optical devices 106. In one embodiment, an optical device can include an optical sensor, such as an infrared sensor, a visible light sensor and/or any device that can sense light and/or electromagnetic energy. The detection of light and/or electromagnetic energy can be used by the computing device 100 to control components of the computing device 100, such as a level of light emitted by a backlight of display 102, illumination of one or more hard keys 103 and any other aspect of computing device 100. In another embodiment, an optical device can include an image-capturing device, such as a digital camera. An image-capturing device can include any device configured to capture an image, such as a complementary metal-oxide-semiconductor (CMOS) active pixel sensor (APS) and a charged coupled device (CCD). Images captured by one or more optical devices 106 can be stored by the computing device 100 as individual image or as a series of images in a video. Individual images and/or video images can be processed by computing device 100 and interpreted as user inputs. While FIG. 1 depicts one optical device 106 pointing in the same direction as the display 102, it is possible for computing device 100 to have any number of optical devices 106 and it is possible for one or more optical devices 106 to be pointed in other directions, such as a rear-facing camera pointing in the opposite direction of display 102.

FIG. 2 depicts an embodiment of internal components of a computing device 200. It should be understood that this is merely an example for discussion, and that a number of additional components, configurations, assemblies and combinations are possible as known in the art. Computing device 200 can include at least one processor 201 that is able to execute instructions stored in one or more memories 202. The one or more memories 202 can include instructions for running an operating system, instructions for running applications within the operating system, a system management agent and any other kind of instructions. The at least one processor 201 can generate information on a display component 203. Display component 203 can include one or more of a display driver, a display card, display 102 or any other hardware and/or software required to display an image or series of images. Computing device 200 can also include a network interface 204 that allows the device to send and receive information signals via a network. Network interface 204 can include any type of network adapter for connecting to a network, such as an adapter to establish a connection to the Internet, to a wired or wireless intranet, to a cellular network or to a wireless network. Computing device 200 can also include a user interface 205. User interface 205 can include one or more components, such as display 102, one or more hard buttons 103, speaker 104, microphone 105 and optical devices 106, that can provide information to a user and/or receive inputs from a user. User interface 205 can also include one or more external components, such as an external keyboard, external mouse, external microphone, external speaker and the like.

Computing device 200 can include at least one power source 206. Power source 206 can provide power to any or all of the other components in computing device 200. As depicted in FIG. 2, power source 206 can be connected to, and provide power to, each of processor 201, memory 202, display 203, network interface 204, and user interface 205. Power source 206 can be any type of power source, such as one or more disposable batteries, a rechargeable battery and the like. In the embodiment where computing device 200 is a portable device, such as a laptop computer, a tablet computer, a cell phone, a hand held computer and the like, the power supply 206 may need to provide power for a period of time between recharging of the power source 206. In other embodiments, computing device 200 can be a desktop computer, workstation, server or other non-portable device that is typically connected to an external power source any time that computing device 200 is active. With such non-portable computing device, certain elements, such as a display, user interface components and the like may also be external to the computing device.

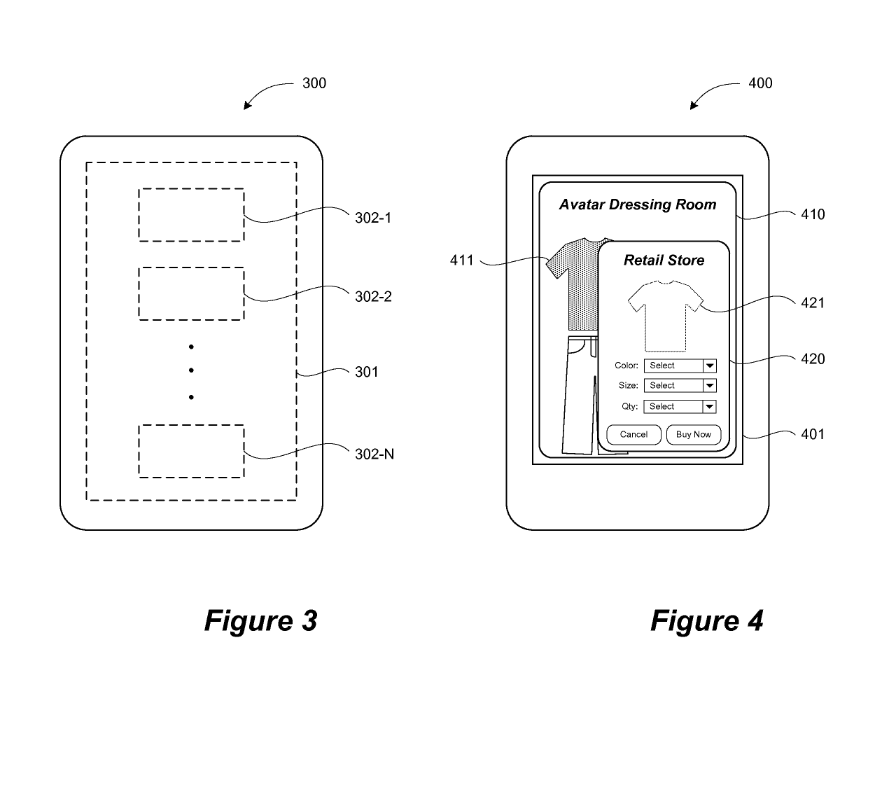

FIG. 3 depicts an embodiment of software on a computing device 300. Computing device 300 can have an operating system 301. The operating system 301 can be configured to operate on a particular type of computing device, such as a desktop computer, a laptop computer, a tablet computer, a cell phone, a personal digital assistant and the like. Any number of applications, such as applications 302-1, 302-2, . . . , 302-N, can be installed on and operate within operating system 301. Applications 302 can provide any number of functions to a user of the computing device. In some examples, one of applications 302 can include one or more of the following: a web browser that provides a user with an ability to browse websites, a message client that allows a user to send and receive messages, a social networking application that allows a user to access a social network and the like. Applications 302 can demand operations from components of the computing device 300, such as display of graphics on a display, play of sounds through a speaker or audio port, network communications by a network interface, reception of user inputs through a user interface and the like. Applications 302 can be stand-alone applications, being able to provide functions without the aid of another application, and applications 302 can be configured to interact with others of applications 302.

FIG. 4 depicts an embodiment of a display of applications running on a computing device 400. Computing device 400 can have a display 401, among any number of other components that are not shown in FIG. 4. In the embodiment depicted in FIG. 4, display 401 shows a first user interface 410 and a second user interface 420. The first user interface 410 and the second user interface 420 can be user interfaces from the same application or from different applications. In the embodiment shown in FIG. 4, the first user interface 410 can be associated with an application that provides users with an avatar and allows users to customize their avatars, such as by dressing avatars in different clothing. The second user interface 420 can be associated with an application that allows users to purchase items from an online retail store.

In one embodiment, to arrive at the arrangement of the user interfaces shown in FIG. 4, the first user interface 410 could have been completely visible showing a shirt 411 and other clothing. The depiction in the first user interface 410 could have included information about the clothing, such as the brand and name of the clothing (e.g., LEVI 501), available colors or styles, type of fabric and the like. When the user selects an item of clothing, such as shirt 411, that item can be highlighted, as is shown by the fill on shirt 411 of first user interface 410. Selecting an article of clothing in first user interface 410 can cause the second user interface 420 to be overlaid over some or all of the first user interface 410. The second user interface 420 can include a depiction 421 of the selected item 411 in the first user interface 410. The second user interface 420 can also include other elements, such as text boxes, drop-down boxes, command buttons and the like to provide additional functionality for the user. In the embodiment depicted in FIG. 4, the second user interface 420 includes drop down boxes to select a color, a size and a quantity of the selected shirt 421, as well as command buttons for enabling a user to make a purchase or close the second user interface 420. When a user chooses to make a purchase, an application associated with the second user interface 420 can send the order to a retail server that can fulfill the order.

In one embodiment, when a user makes a purchase of a physical product via a retail outlet, the user can also be granted ownership of a virtual version of the physical product in the virtual environment. For example, in the embodiment depicted in FIG. 4, when the user makes a purchase of a shirt in second user interface 420, the user can also receive a virtual version of the shirt in the virtual environment provided in the first user interface 410. Receiving a virtual version of the shirt in the virtual environment provided in the first user interface 410 can include allowing the user to place the virtual version of the shirt on the user's avatar in places of the virtual environment where other users can view the shirt. In the embodiment depicted in FIG. 4, the virtual environment provided in the first user interface 410 may allow a user to place a virtual version of physical products on an avatar in a limited way, such as in the avatar dressing room depicted in FIG. 4, but not allow the user to place virtual versions of physical products on an avatar outside of that limited way. In another example, receiving a virtual version of a physical product in a virtual environment can include the virtual environment placing the virtual version of the physical product on a listing of items owned by the user in the user's profile. In another example, receiving a virtual version of a physical product in a virtual environment can include the virtual environment allowing the user to place an image of the physical product on a user's profile image in the virtual environment. Receiving a virtual version of a physical product in a virtual environment can be done in a number of other ways.

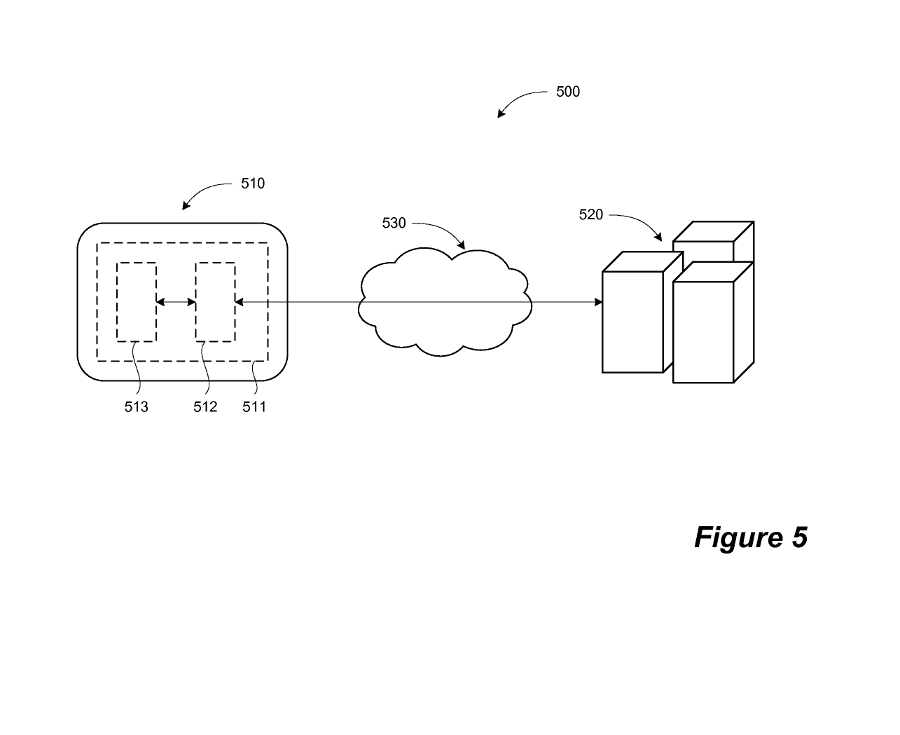

Referring now to FIG. 5, depicted is an embodiment of a computing device interacting with a physical product retail server. The system 500 depicted in FIG. 5 includes a computing device 510 and a retail server 520 connected via a network 530. Computing device 510 includes an operating system 511 and at least two applications 512 and 513. Application 512 can be a retail application provided by an operator of retail server 520. Retail application 512 can operate as a stand-alone application, providing a user with functionality to search for available products and make purchases of those products. Retail application 512 can communicate with retail server 520 to submit search terms and/or queries for available products, to identify available products and information about available products, to receive recommendations about additional products that may be of interest to a user, to transmit purchase requests for fulfillment and the like. Retail server 520 can include one or more computing devices configured to communicate with retail application 512, to service inquiries from retail application 512 about available products and to fulfill product order purchases. In addition to being configured to communicate with application 512, retail server 520 can also be configured to host one or more websites that are accessible via a conventional web browser operating on a computing device.

Application 513 can be an application associated with a virtual environment. For example, virtual environment application 513 can be an application associated with a social network, an application associated with an online game, an application associated with a virtual world and the like. As depicted in FIG. 5, retail application 512 and virtual environment application 513 can communicate with each other. Virtual environment application 513 can send product queries to retail application 512, inquire from retail application 512 as to availability of certain products for purchase, indicate to retail application 512 that a user has selected an item that can be purchased, receive indications from retail application 512 that a user has purchased a physical product, receive renderings of virtual versions of physical products from retail application 512 and so forth.

The retail application 512 can serve as an intermediary between virtual environment application 513 and retail server 520. Doing so can allow a developer of the virtual environment application 513 to interface with retail server 520 without having to know exactly how to interface with retail server 520. In one embodiment, an operator of retail server 520 can provide application developers, such as a developer of virtual environment application 513, with tools in a software development kit (SDK) or an application programming interface (API) that enable virtual environment application 513 to interface with retail application 512 and/or retail server 520. The SDK or API can provide tools for the virtual environment application 513 to send product queries to retail application 512, to inquire from retail application 512 as to availability of certain products for purchase, to indicate to retail application 512 that a user has selected an item that can be purchased, to receive indications from retail application 512 that a user has purchased a physical product, to receive renderings of virtual versions of physical products from retail application 512 and so forth.

The use of retail application 512 as an intermediary between virtual environment application 513 and retail server 520 can have a number of benefits. In one example, the virtual environment application 513 can add the ability to offer products for sale without having to establish an entire backend of a retail fulfillment server, such as warehouses, shipping facilities, inventory and the like. In another example, the retail service operator can increase sales without having to directly market its services to end users as the third party application as the virtual environment application 513 initiates purchases. The retail operator may provide incentives or compensation to the operator of virtual environment application 513 for purchases initiated from virtual environment application 513.

In another example of potential benefits of the system depicted in FIG. 5, the retail application 512 can be configured to display a purchase screen in accordance with an in-app purchasing protocol. Using an in-app purchasing protocol, the retail application 512 can display the purchase screen in a way that appears to the user as if it is a part of the third party application 513. In this manner, the user believe that the purchase screen is a part of the user experience in the third party application 513 and that the user is making an in-app purchase from the third party. Thus, the third party application 513 can appear to have its own purchasing capabilities if the retail application 512 is configured to display retail functions to appear as if they are in-app capabilities of the third party application 513.

In another example of potential benefits of the system depicted in FIG. 5, the user of computing device 510 may opt into a service where the retail server 520 can provide the virtual environment application 513 with information about products that may be relevant or recommended for the user. The relevant or recommended products for the user may be based on a user's previous purchases, products that the user has viewed but not purchased, products that the user placed on a wish list and so on. When the virtual environment application 513 has information about products that may be relevant or recommended for the user, the virtual environment application 513 may show renderings of relevant or recommend products to the user in the virtual environment. Seeing those relevant or recommended products in the virtual environment may prompt the user to purchase the product by initiating a purchase order from virtual environment application 513. Similarly, when a virtual environment application 513 has information about products that may be relevant or recommended for one user, the virtual environment application 513 may more frequently show those types of products to other users that are connected to that user. For example, in a social networking environment, if the social networking environment had information about products that may be relevant or recommended for one user, the social networking environment may display those relevant or recommended products to a user's friends or connections in the social network.

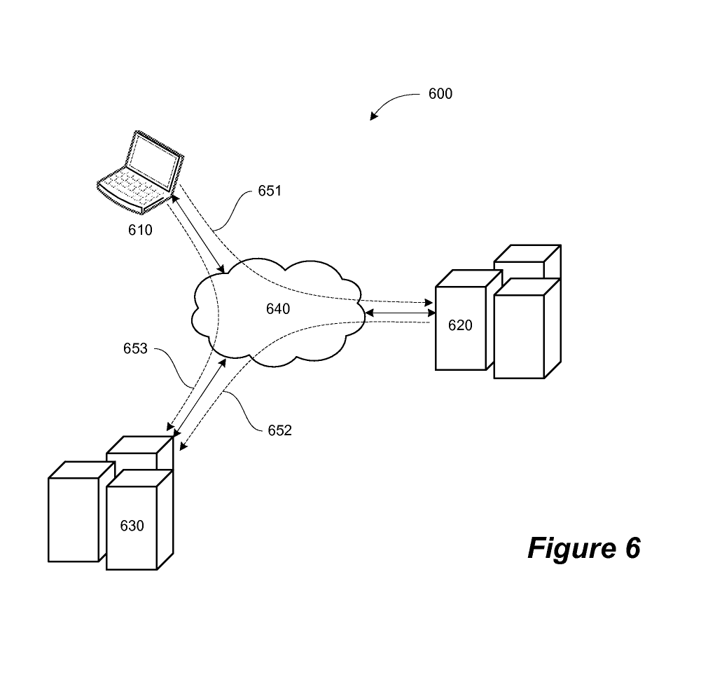

Referring now to FIG. 6, depicted is an embodiment of a system and method of a computing device interacting with a physical product retail server and a virtual environment server. The system 600 depicted in FIG. 6 includes a computing device 610, a retail server 620 and a virtual environment server 630, all of which are connected via a network 640. Computing device 610 can access 651 retail server 620 via network 640. In one example, a user of computing device 610 can use a web browser to access 651 retail sever 620 to search for available products, to make purchases and the like. When a user makes a purchase, the retail server 620 can send 652 an indication of the purchased physical product. The indication of the purchased physical product can include an identification of the physical product, such as a stock keeping unit (SKU) code, a file defining a rendition of a virtual version of the physical product, instructions for rendering a virtual version of the physical product, and other such information. The indication of the purchased physical product can also include an indication of the user or of a user account.

When the virtual environment server 630 receives an indication of a purchased physical product from retail server 620, the virtual environment server 630 can grant the corresponding user account ownership of a virtual version of the purchased physical product. Granting a user account ownership of a virtual version of the purchased physical product can include one or more of permitting an avatar associated with the user account to wear or hold a virtual version of the purchased physical product, placing a virtual version of the purchased physical product on a listing of items owned by the user account, permitting the user to place an image of the purchased physical product on a profile image associated with the user account or any other similar privilege associated with a virtual version of the purchased physical product in the virtual environment.

After a user accesses 651 retail server 620 using computing device 610 and makes a purchase of a physical product, the user can also access 653 the virtual environment server 630 using computing device 610. The computing device 610 may access the virtual environment server 630 using an application associated with the virtual environment, using a web browser or in any other way. When the user accesses 653 the virtual environment server 630, the virtual environment server 630 may have already received indications of one or more purchased physical products and granted ownership of virtual versions of the purchased physical products to the user's account. The user would then have access to those virtual versions of the purchased physical products and be able to customize an avatar, a profile image and the like, of the user's account in the virtual environment.

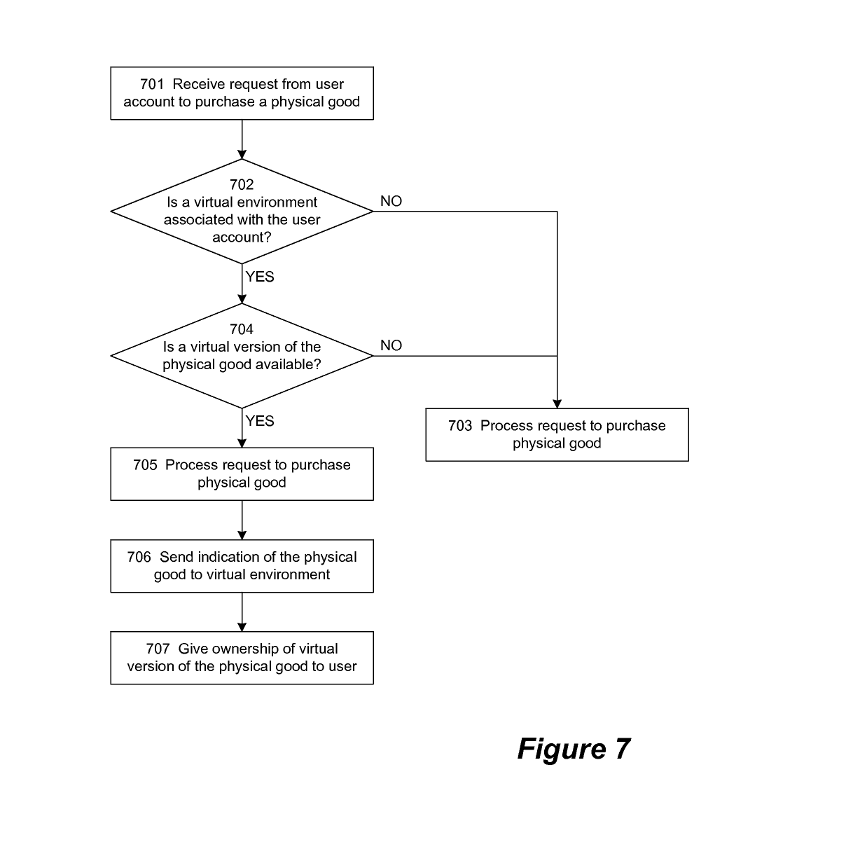

Referring now to FIG. 7, depicted is an embodiment of a method for processing an order for a physical product by a retail server. At block 701, the retail server can receive a request from a user retail account to purchase a physical product. The request to purchase a physical product can be received from a user computing device via a network. At block 702, a determination is made whether a virtual environment is associated with the user retail account. For example, a user may have previously indicated to the retail server that the user has a virtual environment account, such as a social networking account. The user may even register, with the retail server, a user name and password associated with the virtual environment account.

If, at block 702, the retail server determines that no virtual environment is associated with the user retail account, the retail server can proceed to process 703 the request to purchase the physical product. Processing 703 the request to purchase the physical product can include charging an account of the user for the amount of the purchase price, shipping the physical product to the user and so forth. However, if at block 702, the retail server determines that a virtual environment is associated with the user retail account, the retail server can proceed to determine 704 whether a virtual version of the physical product is available. A virtual version of the physical product can be available if the retail server can create a virtual version of the physical product, if the retail server has a file for rendering a virtual version of the physical product, if the virtual environment can create a virtual version of the physical product, if the virtual environment has a file for rendering a virtual version of the physical product or in any number of similar circumstances.

If, at block 704, the retail server determines that no virtual version of the physical product is available, the retail server can proceed to process 703 the request to purchase the physical product. However, if at block 704, the retail server determines that a virtual version of the physical product is available, the retail server can proceed to process 705 the request to purchase the physical product and to send 706 an indication of the physical product to the virtual environment. The indication of the physical product can include an identification of the physical product, such as a SKU code, a file defining a rendition of a virtual version of the physical product, instructions for rendering a virtual version of the physical product and other such information. When sending 706 the indication of the physical product, the retail server can also include an indication of the user or of the user's virtual environment account. At block 707, the virtual environment can grant ownership of the virtual version of the physical product to the user's virtual environment account.

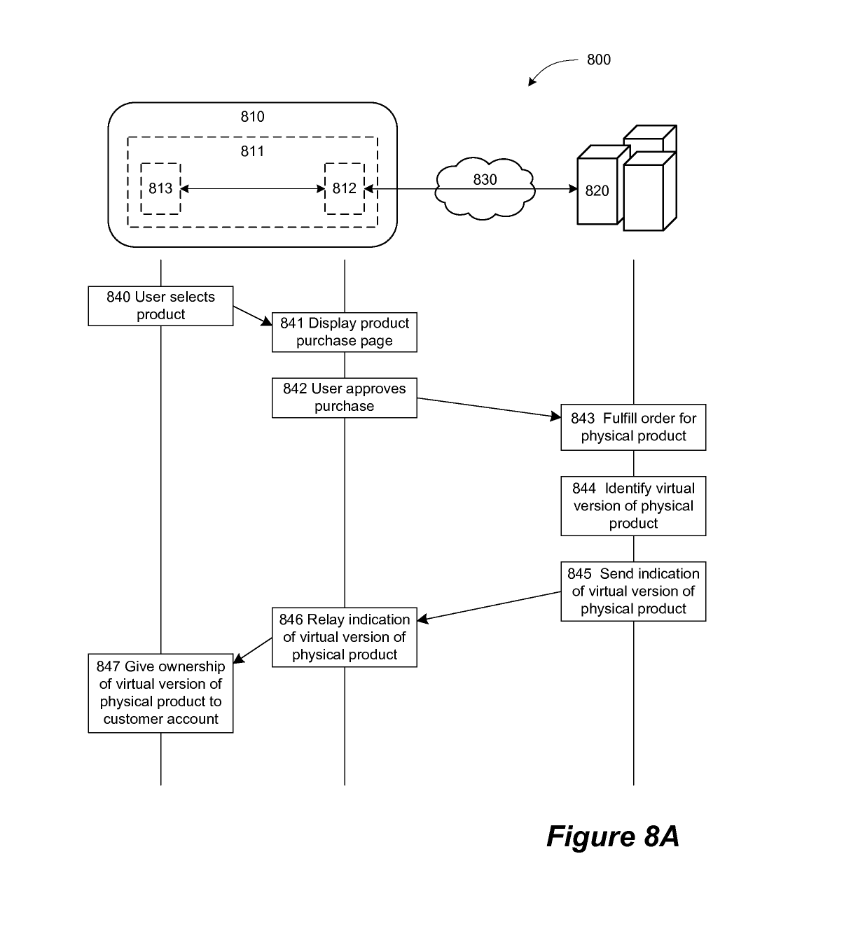

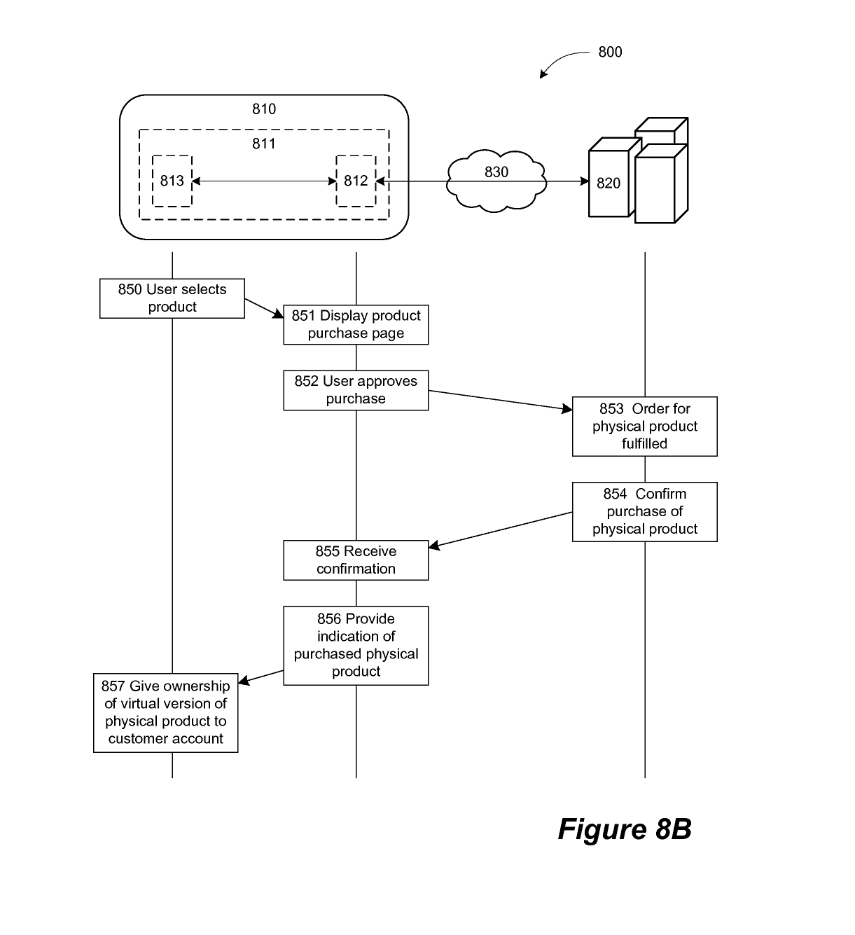

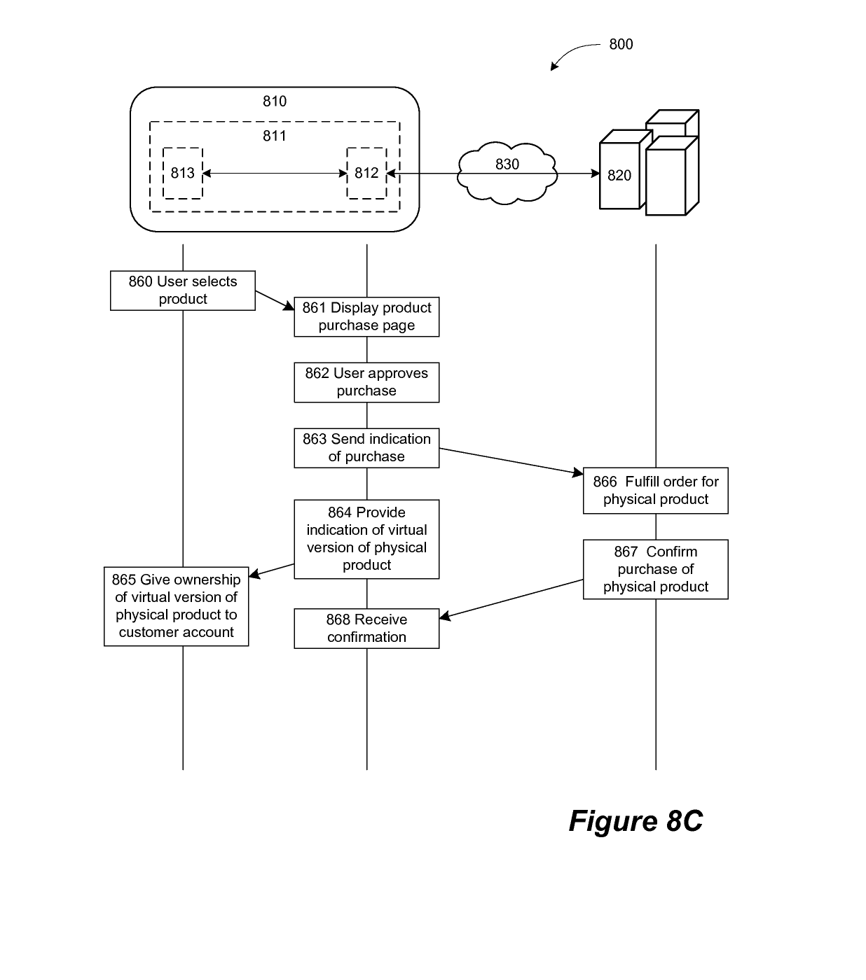

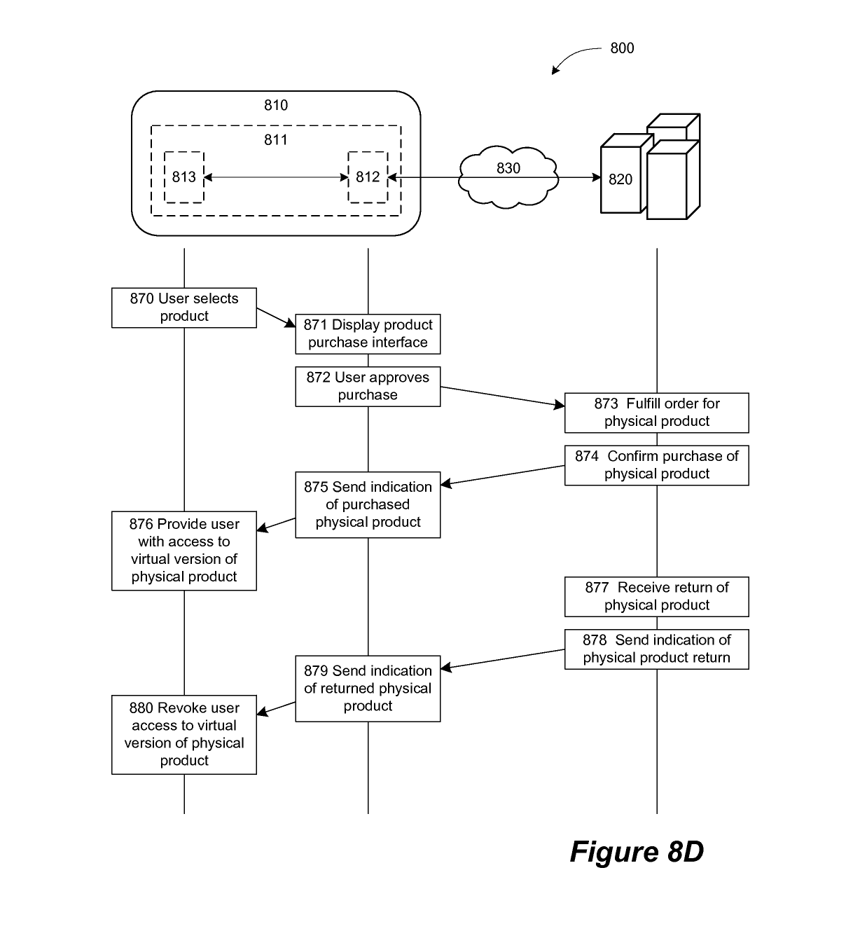

Referring now to FIGS. 8A, 8B, 8C and 8D, depicted are embodiments of interactions between software components on a computing device and a physical product retail server. A system 800 is depicted in each of FIGS. 8A, 8B, 8C and 8D, along with a method of handling requests to purchase physical products. System 800 includes a computing device 810 and a retail server 820 connected via a network 830. Computing device 810 includes an operating system 811 and at least two applications 812 and 813 installed on the operating system 811. In the depictions shown in FIGS. 8A, 8B, 8C and 8D, application 812 can be a retail application and application 813 can be a virtual environment application. Retail application 812 can be configured to communicate with retail server 820 via network 830. Retail application 812 can also be configured to communicate with virtual environment application 813.

FIG. 8A depicts a method that includes a user selecting 840 a product in virtual environment application 813. The product can be displayed in a user interface of the virtual environment application 813, such as the clothing depicted in the first user interface 410 depicted in FIG. 4. When the user selected 840 the product, the virtual environment application 813 can highlight or otherwise demarcate the selected product. The virtual environment application 813 can also send a request to the retail application 812 for the selected product to be displayed in a purchase page. At block 841, the retail application 812 can display a product purchase page for the selected product. The retail application 812 can display the product search page in a second user interface that is overlaid on all or a portion of a first user interface of the virtual environment application 813, such as in the depiction of the second user interface 420 overlaid on a portion of the first user interface 410 in display 401 of FIG. 4. At block 842, the user can approve purchase of the product. Approving purchase of a product can include the user selecting types or styles of the product, entering payment information, entering a shipping address and the like.

At block 843, the retail server 820 can fulfill an order for purchase of the physical product. Fulfilling the request to purchase the physical product can include charging an account of the user for the amount of the purchase price, shipping the physical product to the user and so forth. At block 844, the retail server 820 can identify a virtual version of the physical product. The virtual version of the physical product can be identified by the retail server creating a virtual version of the physical product, by the retail server locating a file for rendering a virtual version of the physical product, by the retail server identifying or creating instructions for rendering a virtual version of the physical product or by any other manner. Once the retail server identifies a virtual version of the physical product, then, at block 845, the retail server 820 can send an indication of the virtual version of the physical product to the retail application of computing device 810. The indication of the virtual version of the physical product include one or more of a file for rendering a virtual version of the physical product, instructions for rendering a virtual version of the physical product, a code (such as a SKU code) for identifying the virtual version of the physical product, a link to any of the foregoing or any other type of indication of the virtual version of the physical product. At block 846, the retail application 812 can receive the indication of the virtual version of the physical product and relay the indication to the virtual environment application 813. At block 847, the virtual environment application 813 can give ownership of the virtual version of the physical product to the user's virtual environment account. Giving a user's virtual environment account ownership of a virtual version of a purchased physical product can include one or more of permitting an avatar associated with the virtual environment account to wear or hold a virtual version of the purchased physical product, placing a virtual version of the purchased physical product on a listing of items owned by the virtual environment account, permitting the user to place an image of the purchased physical product on a profile image associated with the virtual environment account or any other similar privilege associated with a virtual version of the purchased physical product in the virtual environment.

FIG. 8B depicts a method that includes a user selecting 850 a product in virtual environment application 813. At block 851, the retail application 812 can display a product purchase page for the selected product. At block 852, the user can approve purchase of the product shown in the product purchase page. At block 853, the retail server 820 can fulfill an order for purchase of the physical product. At block 854, the retail server 820 can send a confirmation that the physical product has been purchased. At block 855, the retail application 812 can receive the confirmation that the physical product has been purchased. When the retail application 812 receives confirmation that the physical product has been purchased, the retail application can display an indication that the physical product was purchased successfully. Such an indication can include details about shipping of the physical purchased product, a confirmation number, a receipt and so forth. At block 856, the retail application 812 can provide an indication of the purchased physical product to the virtual environment application 813. The indication of the purchased physical product can include information that is stored by retail application 812 locally on computing device 810. At block 857, the virtual environment application 813 can give ownership of the virtual version of the physical product to the user's virtual environment account. Giving a user's virtual environment account ownership of a virtual version of a purchased physical product can include one or more of permitting an avatar associated with the virtual environment account to wear or hold a virtual version of the purchased physical product, placing a virtual version of the purchased physical product on a listing of items owned by the virtual environment account, permitting the user to place an image of the purchased physical product on a profile image associated with the virtual environment account or any other similar privilege associated with a virtual version of the purchased physical product in the virtual environment.

FIG. 8C depicts a method that includes a user selecting 860 a product in virtual environment application 813. At block 861, the retail application 812 can display a product purchase page for the selected product. At block 862, the user can approve purchase of the product shown in the product purchase page. At block 863, the retail application 812 can send an indication of the purchase to the retail server 820. At block 864, the retail application 812 can send an indication of the virtual version of the physical product to the virtual environment application 813. At block 865, the virtual environment application 813 can give ownership of the virtual version of the physical product to the user's virtual environment account. At block 866, the retail server 820 can fulfill the order for the physical product. At block 867, the retail server 820 can send a confirmation of the purchase of the physical product to the retail application 812. At block 868, the retail application 812 can receive the confirmation that the physical product has been purchased. When the retail application 812 receives confirmation that the physical product has been purchased, the retail application can display an indication that the physical product was purchased successfully. Such an indication can include details about shipping of the physical purchased product, a confirmation number, a receipt and so forth. As shown in FIG. 8C, the retail application 812 can provide virtual environment application 813 with an indication of the virtual version of the physical product before the retail application 812 receives confirmation of the purchase of the physical product from retail server 820.

FIG. 8D depicts a method that includes a user selecting 870 a rendering of a product in virtual environment application 813. At block 871, the retail application 812 can display a product purchase interface for the selected product. At block 872, the user can approve purchase of the product shown in the product purchase interface. At block 873, the retail server 820 can fulfill an order for purchase of the physical product. At block 874, the retail server 820 can send a confirmation that the physical product has been purchased. At block 875, the retail application 812 can send an indication of the purchased physical product to virtual environment application 813. At block 876, the virtual environment application 813 can provide a user virtual environment account with access to the virtual version of the physical product.

At block 877, the retail server 820 can receive a return of the physical product. Many retailers allow consumers to return purchased items for a full or partial refund of the purchase price. For example, the user can ship the physical product back to a warehouse of the retail server, and the retail server 820 can receive an indication that the physical produce has been shipped to or received by the warehouse. At block 878, the retail server 820 can send an indication to the retail application 812 of the return of the physical product. At block 879, the retail application 812 can send an indication of the purchased physical product to virtual environment application 813. At block 880, the virtual environment application 813 can revoke the user virtual environment account's access to the virtual version of the physical product. In this way, the virtual environment application 813 can provide access to virtual version of only those physical products that the user has actually purchased and not returned.

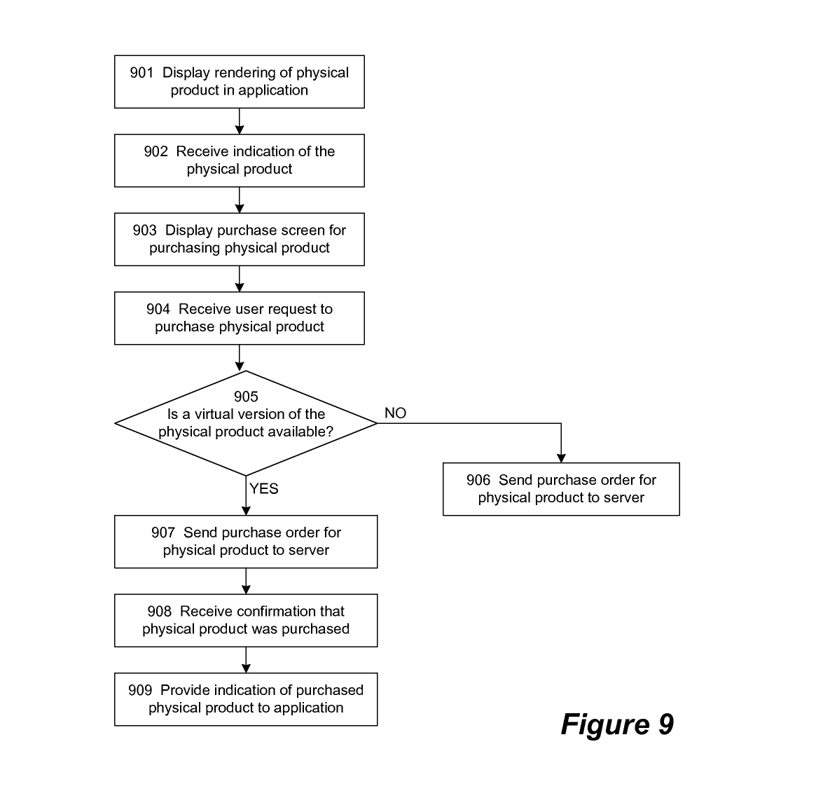

FIG. 9 depicts an embodiment of a method for processing an order for a physical product by a retail application operating on a computing device. At block 901, a rendering of a physical product can be displayed in a third party application. At block 902, the retail application can receive an indication of a physical good from the third party application. The third party application may have been developed using an SDK or an API to provide the third party application with the ability to appropriately communicate the indication of the physical good to the retail application. At block 903, the retail application can display a purchase screen for purchasing the physical good. In one embodiment, the third party may offer products for sale exclusively through the third party application. In such a case, the retail application may be configured to present the display page for the particular product only when prompted to by the third party application. In another embodiment, an operator of the retail service may provide incentives or compensation to third parties when a user initiates a purchase of a product in the third party application. At block 904, the retail application may receive a request to purchase the physical product from the user.

At block 905, the retail application may determine whether a virtual version of the physical product is available. The retail application may have information locally about the availability of a virtual version of the physical product or the retail application may contact a remote server regarding the availability a virtual version of the physical product. If the retail application determines that a virtual version of the physical product is not available then, at block 906, the retail application determines that no virtual version of the physical product is available then the retail server can proceed directly to block 906 where the retail application may send the purchase order for the physical product to a server for fulfillment of the purchase order. However, if, at block 905, the retail application determines that a virtual version of the physical product is available then, at block 907, the retail application can send the purchase order for the physical product to a server for fulfillment of the purchase order and, at block, 908, the retail application can receive a confirmation that the physical product was purchased. Then, at block 909, the retail application can provide the third party application with an indication of the virtual version of the physical product.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed:

1. A method for processing a request to purchase a product, the method comprising:
receiving, by a retail application operating on a computing device, a request, from a virtual environment application operating on the computing device, to display a product purchase page;
displaying the product purchase page;
receiving, from a user of the computing device via the product purchase page, a request to purchase a product;
sending, from the retail application to a retail server, the request to purchase the product, wherein the retail server is configured to fulfill the request to purchase the product and to determine whether a virtual version of the product is available;
receiving, by the retail application from the retail server, an indication of the virtual version of the product; and
providing, from the retail application to the virtual environment application, the indication of the virtual version of the product;
wherein the virtual environment application is configured to provide the virtual version of the physical product to a virtual environment account associated with the user of the computing device.

2. The method of claim 1, wherein the indication of the virtual version of the product comprises a file for rendering the virtual version of the product.

3. The method of claim 2, wherein the retail server is configured to create the file for rendering the virtual version of the product.

4. The method of claim 1, wherein the indication of the virtual version of the product comprises instructions for rendering the virtual version of the product.

5. A system for providing retail capability to an application, the system comprising:
a computing device; and
a first application operating on the computing device, wherein the first application comprises instructions that, upon execution on the computing device, at least cause the first application to:
receive, from a second application operating on the computing device, a request to display a rendering of a product,
render the product on a display,
receive, from a user of the computing device, a request to purchase the product, and
in response to receiving the request to purchase the product, provide an indication of the product to the second application, wherein the second application is configured to provide a virtual version of the product to an account associated with the user of the computing device.

6. The system of claim 5, wherein the second application is associated with a virtual environment.

7. The system of claim 6, wherein the second application is configured to provide the virtual version of the product to an account associated with the user of the computing device by permitting the user of the computing device to customize an avatar in the virtual environment with the virtual version of the product.

8. The system of claim 6, wherein the second application is configured to provide the virtual version of the product to an account associated with the user of the computing device by permitting the user of the computing device to customize a profile image in the virtual environment with the virtual version of the product.

9. The system of claim 5, wherein the second application is configured to display a rendering of the product to the user of the computing device before displaying a product purchase interface.

10. The system of claim 9, wherein the second application is configured to send a request to display the product purchase interface in response to receiving a selection of the rendering of the product by the user of the computing device.

11. The system of claim 5, wherein the first application further comprises instructions that, upon execution on the computing device, at least cause the first application to:
send the request to purchase the product to a retail server;
wherein the retail server is configured to fulfill the request to purchase the product.

12. The system of claim 11, wherein the retail server is configured to determine whether a retail account of the user of the computing device is associated with a virtual environment account.

13. The system of claim 12, wherein the retail server is configured to send, to the first application, the indication of the virtual version of the product in response to determining that the retail account of the user of the computing device is associated with the virtual environment account.

14. The system of claim 12, wherein the retail server is configured to determine whether the virtual version of the product is available.

15. The system of claim 14, wherein the retail server is configured to determine create the virtual version of the product in response to determining that the virtual version of the product is not available.

16. The system of claim 5, wherein the indication of the virtual version of the product comprises a code for identifying the virtual version of the product.

17. The system of claim 16, wherein the code comprises a stock keeping unit (SKU) code.

18. A non-transitory computer-readable storage medium having stored thereon computer readable instructions, the computer readable instructions comprising instructions that, upon execution on a computing device, at least cause:
displaying a first user interface associated with a first application operating on the computing device, the first user interface comprising a virtual environment;
allowing a user of the computing device to interact with a rendering of a product in a first area of the virtual environment;
receiving, from a user of the computing device, a selection of the rendering of the product;
in response to receiving the selection of the rendering of the product, displaying a product purchase interface for the product;
receiving, by the first application from a second application, an indication that the user purchased the product; and
in response to receiving the indication that the user purchased the product, allowing the user to interact with the rendering of the product in at least a second area of the virtual environment.

19. The non-transitory computer-readable storage medium of claim 18, wherein the first application is configured to send the request to display the product purchase interface for the product in accordance with one or more of a software development kit (SDK) associated with the retail application or an application programming interface (API) associated with the retail application.

20. The non-transitory computer-readable storage medium of claim 18, wherein the first area of the virtual environment comprises an area in which an avatar of the user of the computing device can interact with the rendering of the product.

21. The non-transitory computer-readable storage medium of claim 18, wherein the rendering of the product comprises a rendering of an item of clothing.

22. The non-transitory computer-readable storage medium of claim 21, wherein allowing the user of the computing device to interact with the rendering of the product in the first area of the virtual environment comprises allowing an avatar of the user of the computing device to wear the rendering of the item of clothing in an area not accessible to other users in the virtual environment.

23. The non-transitory computer-readable storage medium of claim 21, wherein allowing the user of the computing device to interact with the rendering of the product in at least the second area of the virtual environment comprises allowing an avatar of the user of the computing device to wear the rendering of the item of clothing in an area accessible to other users in the virtual environment.

24. The non-transitory computer-readable storage medium of claim 18, wherein the computer-readable instructions comprising instructions that, upon execution on a computing device, at least cause:
displaying, to the user of the computing device, information about the product in the first area of the virtual environment.

25. The non-transitory computer-readable storage medium of claim 18, wherein the computer-readable instructions comprising instructions that, upon execution on a computing device, at least cause:
displaying, to at least one other user, information about the product in at least the second area of the virtual environment.

26. The non-transitory computer-readable storage medium of claim 18, wherein the first application is configured to receive, from the second application, a recommendation to display the product to the user.

27. The non-transitory computer-readable storage medium of claim 26, wherein the second application is configured to provide the recommendation to display the product to the user based on a browsing history of the user.

28. The non-transitory computer-readable storage medium of claim 26, wherein the second application is configured to provide the recommendation to display the product to the user based on a purchase history of the user.
